(19) United States
(12) Patent Application Publication
(10) Pub. No.: US 2012/0274251 A1
(43) Pub. Date: Nov. 1, 2012

(54) HARMONIC NOISE REDUCTION

(75) Inventor: Charles J. Romenesko, Rockford, IL (US)

(73) Assignee: Danfoss Drives A/S, Graasten (DK)

(21) Appl. No.: 13/097,234

(22) Filed: Apr. 29, 2011

(51) Int. Cl. H02P 6/00

(52) U.S. Cl. 318/400.24

(57) ABSTRACT

The present invention relates to a method for regulating a set of first noise harmonics from an electronic device operatively connected to a power supply unit, the method comprising the step of injecting a second set of harmonics into a representation of a drive current provided to the electronic device in order to regulate at least part of the noise harmonics of the first set, wherein the harmonics of the second set is/are different from the noise harmonics of the first set. The invention further relates to a power supply unit for performing the method of the present invention.

### FIELD OF THE INVENTION

The present invention relates to a method and a system for reducing harmonic noise from permanent magnet machine systems. In particular, the present invention relates to a method and a system for injecting additional current harmonics into a motor current in order to suppress other harmonics generated by the permanent magnet machine system.

### BACKGROUND OF THE INVENTION

During recent years different permanent magnet (PM) machine designs have been introduced to the market. Trapezoidal and sinusoidal back electromotive force (EMF) are representations of two specific PM designs. However, new cost effective PM designs blur the lines between these two specific PM designs, and future PM inverters must be able to handle these two extreme PM designs as well as any intermediate PM design.

Similarly, ‘surface mount PM’ vs ‘interior PM’ is a traditional description that was used to distinguish between non-salient and salient machines (Ld=Lq and Lq≠Ld). Here too, new advancements of powdered core segmented stator designs with low flux densities and softer saturation characteristics, inside out machine designs, and low cost needle point stator winding techniques are blurring the lines that previously segmented the market of PM inverters.

A square wave or a sinusoidal drive current provided to an intermediate machine solution will generate 5^{th}, 7^{th}, 11^{th} and 13^{th} harmonic ripple currents and corresponding 6^{th} and 12^{th} harmonic ripple torques. These harmonics produce undesirable audible noise at 300 Hz to 600 Hz (assuming 50 Hz operation).

Harmonic regulation/suppression has been used in conjunction with zero magnitude references to produce lower distortion fundamental current waveforms for active front ends and DC/AC inverters used as isolated power supplies. These power supplies are often referred to as inverters capable of supplying non-linear loads with low voltage total harmonic distortion (THD). Similarly, 3^{rd} harmonic voltage injection (or 9^{th}, 15^{th}, 21^{st} etc.) is regularly used to increase the fundamental voltage waveform magnitude given limited DC link voltages.

Examples of known methods are disclosed in U.S. Pat. No. 6,777,907, U.S. Pat. No. 7,034,493 and U.S. Pat. No. 6,674,262.

It may be seen as an object of embodiments of the present invention to provide a simple way to suppress noise harmonics from permanent magnet machine systems, such as those using permanent magnet motors.

### DESCRIPTION OF THE INVENTION

The above-mentioned object is complied with by providing, in a first aspect, a method for regulating a set of first noise harmonics from an electronic device operatively connected to a power supply unit, the method comprising the step of injecting a second set of harmonics into a representation of a drive current provided to the electronic device in order to regulate at least part of the noise harmonics of the first set, wherein the harmonics of the second set is/are different from the noise harmonics of the first set.

The present invention is of particular relevance in connection with non-optimized PM motors, such as “cheap” PM motors. In “cheap” PM motors, the sinusoidal back EMF voltage is sacrificed to save manufacturing costs. In “cheap” PM motors the back EMF voltage becomes non-sinusoidal. The torque generated by the product of a sinusoidal motor current and a non-sinusoidal voltage will not be smooth, and it will generate noise. Thus, the present invention aims at generating and injecting a non-sinusoidal motor current to minimize noise generated by ripple torque.

Thus, the method according to the first aspect of the present invention is of particular relevance in connection with control of PM machines, such as PM motors. It is an advantage of the present invention that the power supply unit in the form of a single motor inverter may be tailored to drive several different PM motor designs.

The individual harmonics of the second set may be weighted in accordance with an injection factor. In fact the individual harmonics of the second set may be weighted differently, and they may be weighted between −125% and 125%.

The noise harmonics of the first set may comprise the 5^{th}, 7^{th}, 11^{th} and 13^{th} harmonics, whereas the harmonics of the second set may comprise the 6^{th} and 12^{th} harmonics.

Thus, it is an advantage of the present invention that the 5^{th}, 7^{th}, 11^{th} and 13^{th} noise harmonics generated by for example permanent magnet motors may be controlled by the injection and regulation of the 6^{th} and 12^{th} harmonics.

In a second aspect the present invention relates to a method for regulating a first noise harmonic from an electronic device operatively connected to a power supply unit, the method comprising the step of injecting at least one second harmonic into a representation of a drive current provided to the electronic device in order to suppress the first noise harmonic, wherein the second harmonic is different from the first noise harmonic.

Again, the method is of particular relevance in connection with control of PM machines, such as PM motors. It is an advantage of the present invention that a single motor inverter may be tailored to drive several different PM motor designs.

The first noise harmonic may be selected from the group consisting of the 5^{th}, 7^{th}, 11^{th} and 13^{th} harmonics, whereas the second harmonic may comprise the 6^{th} and/or the 12^{th} harmonics.

In a third aspect the present invention relates to a power supply for regulating a set of first noise harmonics from an electronic device operatively connected to a power supply unit, said power supply comprising means for generating and injecting a second set of harmonics into a representation of a drive current provided to the electronic device in order to regulate at least part of the noise harmonics of the first set, wherein the harmonics of the second set is/are different from the noise harmonics of the first set.

The power supply of the present invention is of particular relevance in connection with control of PM machines, such as PM motors. It is an advantage that the power supply may be tailored to drive several different PM motor designs.

The means for generating and injecting the second set of harmonics may be adapted to weight individual harmonics of the second set in accordance with an injection factor.

The power supply may be adapted to regulate the 5^{th}, 7^{th}, 11^{th} and 13^{th} harmonics of the first set by injecting the 6^{th} and/or the 12^{th} harmonics into the representation of a drive current.

In a fourth aspect the present invention relates to a power supply for regulating a first noise harmonic from an electronic device operatively connected to a power supply unit, said power supply comprising means for generating and injecting a second harmonic into a representation of a drive current provided to the electronic device in order to suppress the first noise harmonic, wherein the second harmonic is different from the first noise harmonic.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present invention will now be described in further details with reference to the accompanying figures, wherein:

FIG. 1 shows various currents at injection factor 0%,

FIG. 2 shows various currents at injection factor 50%,

FIG. 3 shows various currents at injection factor 100%,

FIG. 4 shows various currents at injection factor 125%,

FIG. 5 shows various currents at injection factor −50%, and

FIG. 6 shows various currents at injection factor −100%.

While the invention is susceptible to various modifications and alternative forms, specific embodiments have been shown by way of examples in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE INVENTION

In general the present invention relates to a method and a system where noise harmonics generated by, for example, permanent magnet motors are controlled by the injection and regulation of particular harmonics in the stationary frame indirectly by injection and regulation of other harmonics in the commonly used dq reference frame.

In particular, the present invention addresses a method and a system involving injection and regulation of 5^{th}, 7^{th}, 11^{th}, and 13^{th} harmonics in the stationary frame indirectly by injection and regulation of only the 6^{th} and 12^{th} harmonics in the commonly used dq reference frame. The convolution of the 6^{th} and 12^{th} harmonics coordinate transformations with the fundamental coordinate transformation allows regulation of five separate harmonic frequencies with only two additional reference calculations.

The present invention relies on the fact that an identical convolution of frequencies occurs between the machine stator and rotor fluxes to produce 6^{th} and 12^{th} harmonic ripple torques. In relation to this the present invention takes advantage of the fact that the cylindrical symmetry will not be compromised in cost effective permanent magnet machines/motors.

Thus, according to the present invention the control of several harmonics is done by the injection of only two harmonics.

It is a huge advantage of the present invention that by varying the absolute and relative amplitudes of the injected harmonics the drive waveform can be tailored to match a given motor design. Moreover, the method and system of the present invention is not calculation intensive and, thus, requires minimal additional computational resources.

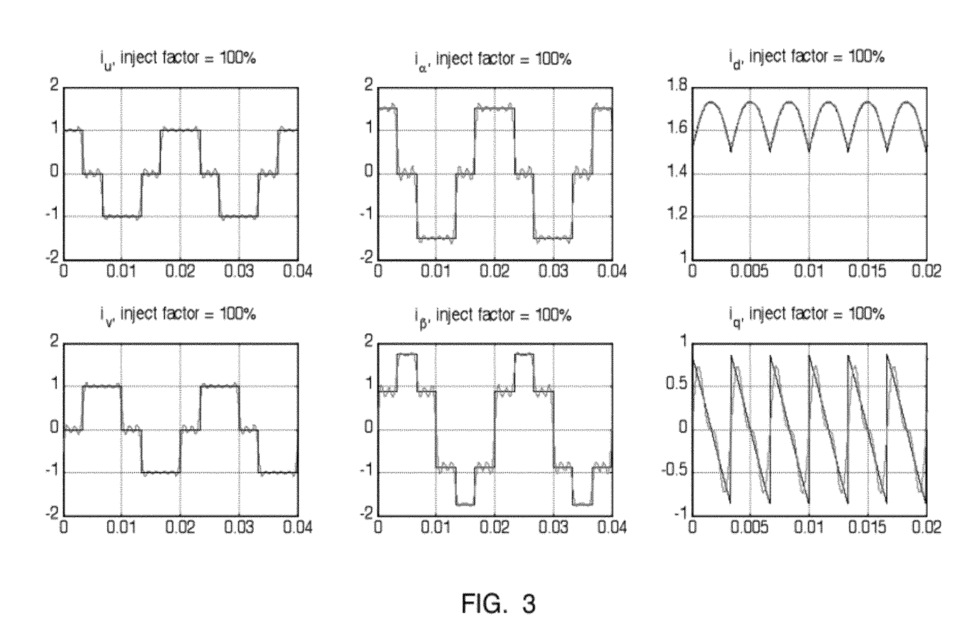

By injecting the 6^{th} and/or 12^{th} harmonic currents of a proper magnitude into the current references id and iq a sine wave current regulator can slowly be changed into a trapezoidal current regulator—cf. in particular FIG. 3. The ratios of the 6^{th} and 12^{th} harmonics may be tailored to match a given motor design by varying an injection factor.

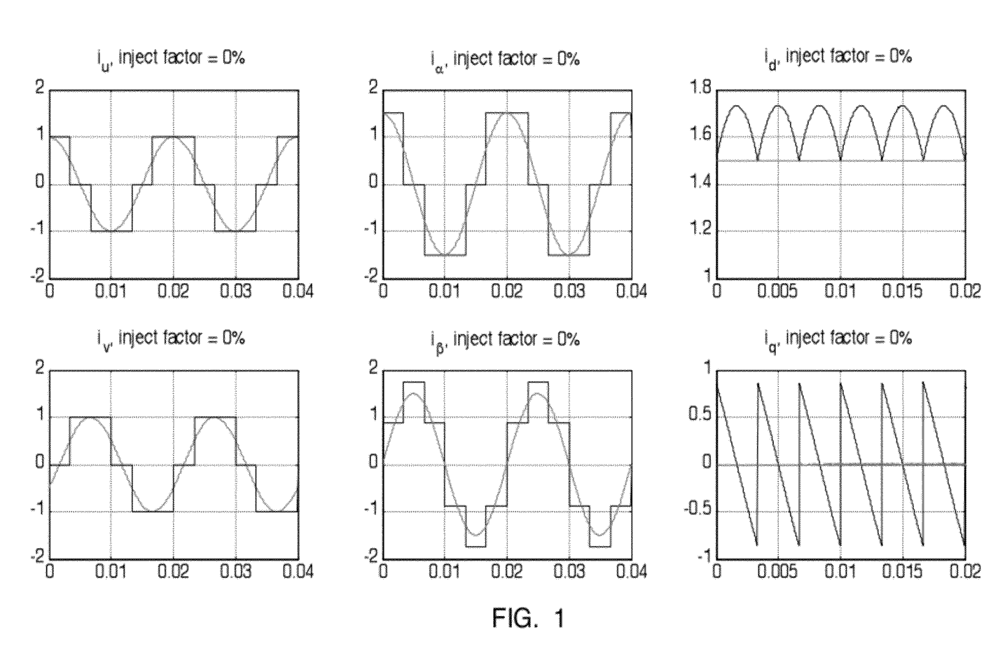

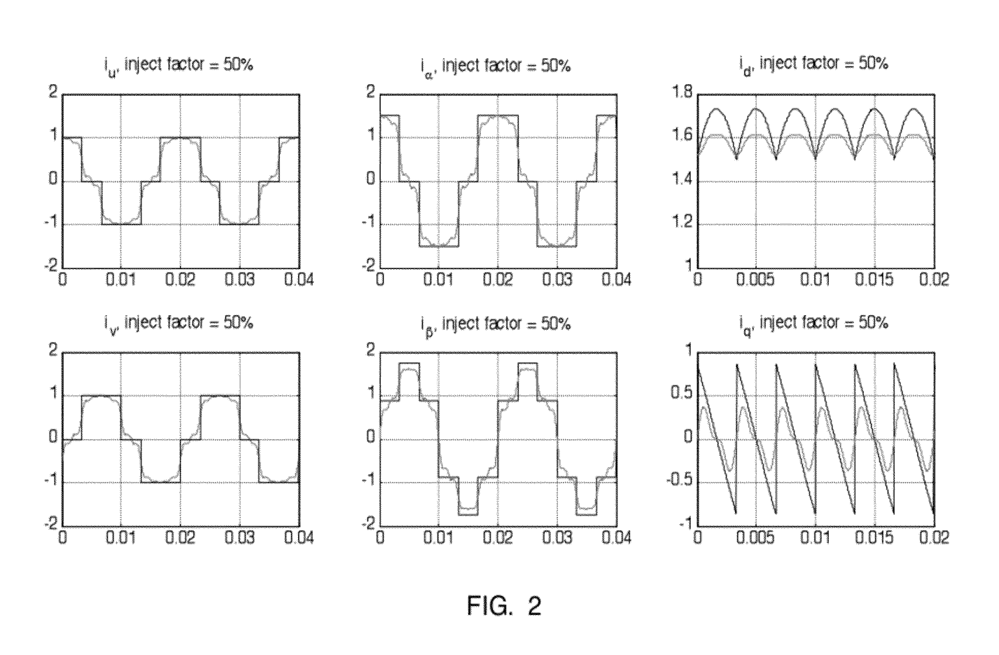

FIGS. 1-3 show how the sine wave drive can be changed into a trapezoidal-shaped drive current by increasing an injection factor from 0 to 100%—in FIG. 1 the injection factor is 0%, in FIG. 2 the injection factor is 50%, and in FIG. 3 the injection factor is 100%.

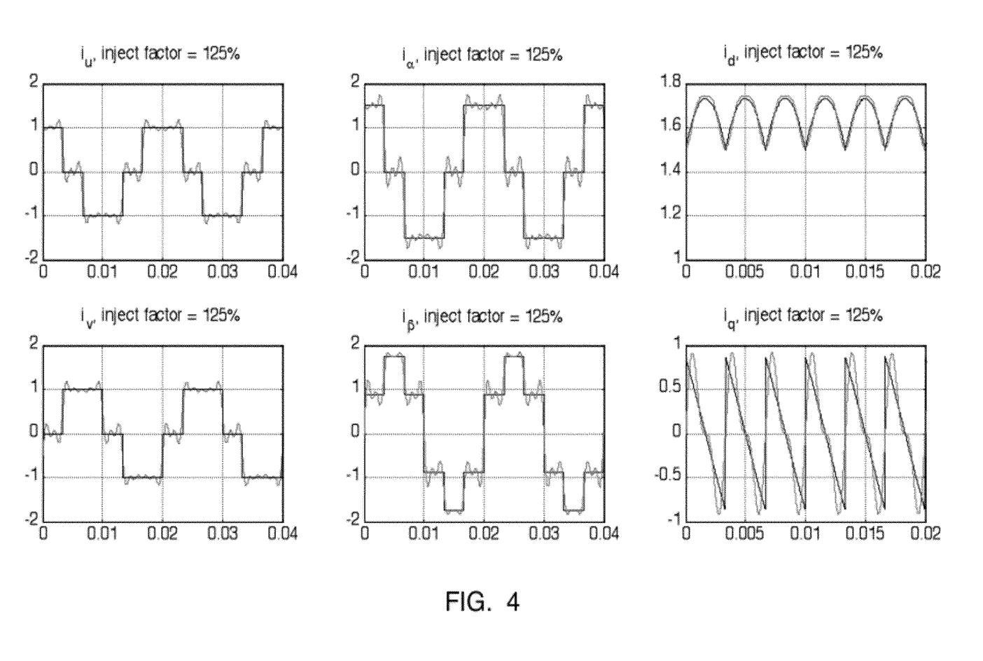

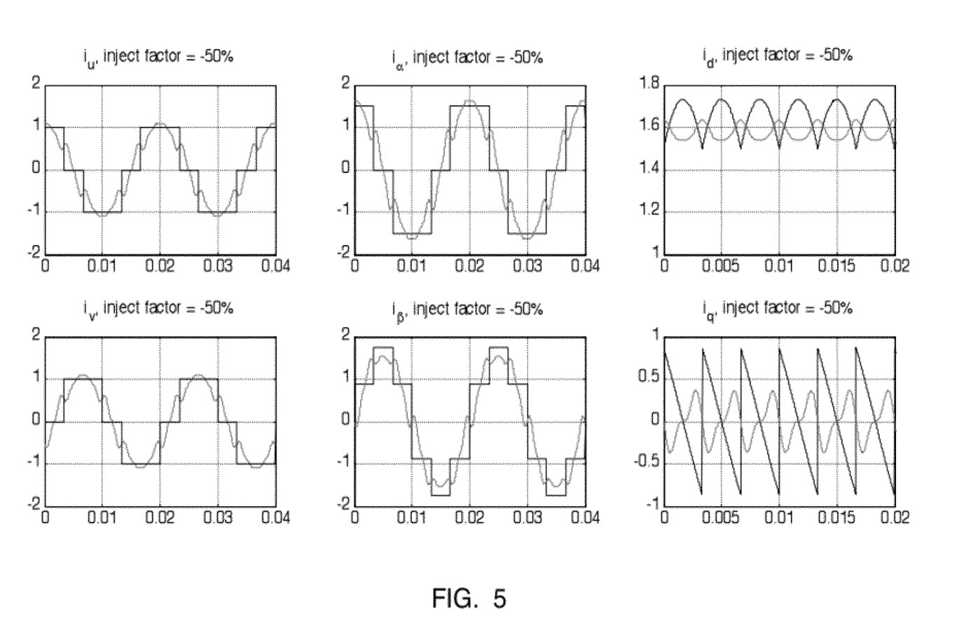

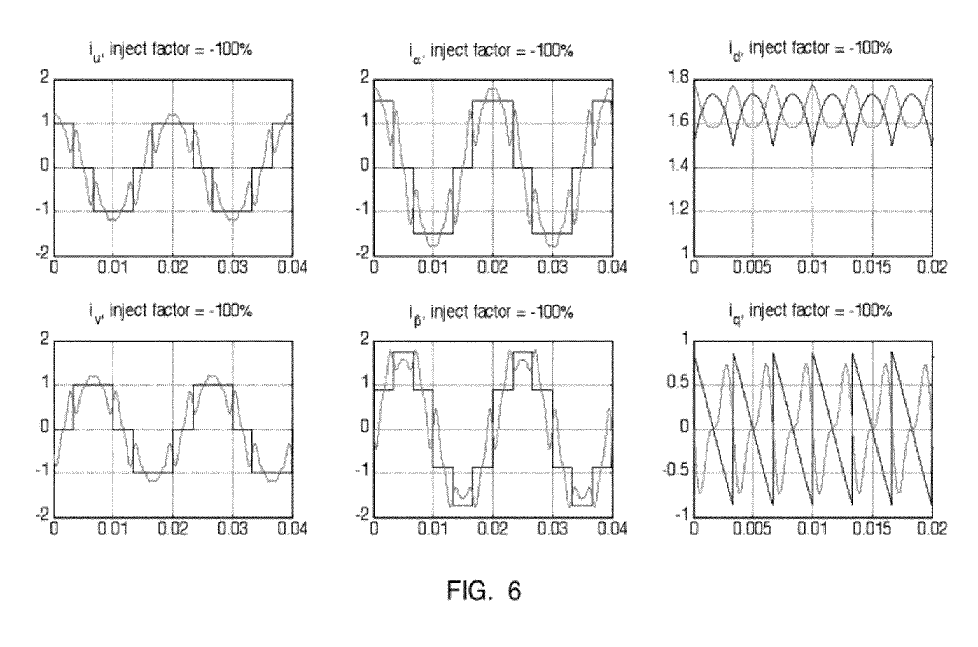

Generally, the three phases of an inverter are denoted u,v,w. Thus, iᵤ and iᵥ denote drive currents from phase u and v, respectively. Abbreviations α and β represent two phase equivalents of the three phases u,v,w. Since a motor has three windings connected in a wye-connection, it is only a two variable problem. The conversion from u,v,w to α, β is a well known conversion for a person skilled in the art. Abbreviations d and q denote rotating reference frame equivalents of α and β. The conversion from d and q to α and β is also well known to a person skilled in the art. FIGS. 4-6 illustrate drive currents for injection factors of 125%, −50% and −100%, respectively.

By varying the injection factor between −125% and 125% the entire system can be tested and audible noise can be minimized at the installation site. Since PM motor designs of the future will not be ideal sine waves or ideal trapezoids, the ability to adjust 6^{th} and/or 12^{th} harmonic current injection will provide a unique solution where a single inverter may be configured for use with several different PM motor designs without sacrificing on audible noise levels. Moreover, it is of particular importance that this system level noise optimization experiment only has to be performed once for a given motor design.

While the present invention has been illustrated and described with respect to a particular embodiment thereof, it should be appreciated by those of ordinary skill in the art that various modifications to this invention may be made without departing from the spirit and scope of the present invention.

What is claimed is:

1. A method for regulating a set of first noise harmonics from an electronic device operatively connected to a power supply unit, the method comprising the step of injecting a second set of harmonics into a representation of a drive current provided to the electronic device in order to regulate at least part of the noise harmonics of the first set, wherein the harmonics of the second set is/are different from the noise harmonics of the first set.

2. The method according to claim 1, wherein individual harmonics of the second set are weighted in accordance with an injection factor.

3. The method according to claim 2, wherein the individual harmonics of the second set are weighted differently.

4. The method according to claim 2, wherein the individual harmonics of the second set are weighted between −125% and 125%.

5. The method according to claim 1, wherein the noise harmonics of the first set comprise the 5^{th}, 7^{th}, 11^{th} and 13^{th} harmonics.

6. The method according to claim 1, wherein the harmonics of the second set comprise the 6^{th} and 12^{th} harmonics.

7. A method for regulating a first noise harmonic from an electronic device operatively connected to a power supply unit, the method comprising the step of injecting at least one second harmonic into a representation of a drive current provided to the electronic device in order to suppress the first noise harmonic, wherein the second harmonic is different from the first noise harmonic.

8. The method according to claim 7, wherein the first noise harmonic is selected from the group consisting of the 5^{th}, 7^{th}, 11^{th} and 13^{th} harmonics.

9. The method according to claim 7, wherein the second harmonic comprises the 6^{th} and/or the 12^{th} harmonics.

10. A power supply for regulating a set of first noise harmonics from an electronic device operatively connected to a power supply unit, said power supply comprising means for generating and injecting a second set of harmonics into a representation of a drive current provided to the electronic device in order to regulate at least part of the noise harmonics of the first set, wherein the harmonics of the second set is/are different from the noise harmonics of the first set.

11. The power supply according to claim 10, wherein the means for generating and injecting the second set of harmonics is adapted to weight individual harmonics of the second set in accordance with an injection factor.

12. The power supply according to claim 10, said power supply being adapted to regulate the 5^{th}, 7^{th}, 11^{th} and 13^{th} harmonics of the first set.

13. The power supply according to claim 10, said power supply being adapted to inject the 6^{th} and 12^{th} harmonics into the representation of a drive current.

14. A power supply for regulating a first noise harmonic from an electronic device operatively connected to a power supply unit, said power supply comprising means for generating and injecting a second harmonic into a representation of a drive current provided to the electronic device in order to suppress the first noise harmonic, wherein the second harmonic is different from the first noise harmonic.
